(19) United States
(12) Patent Application Publication
(10) Pub. No.: US 2021/0109346 A1
(43) Pub. Date: Apr. 15, 2021

(54) SCHEDULING IMAGE COMPOSITION IN A PROCESSOR BASED ON OVERLAPPING OF AN IMAGE COMPOSITION PROCESS AND AN IMAGE SCAN-OUT OPERATION FOR DISPLAYING A COMPOSED IMAGE

(71) Applicant: QUALCOMM Incorporated, San Diego, CA (US)

(72) Inventors: Dam Backer, San Diego, CA (US); Brian Ellis, San Diego, CA (US)

(21) Appl. No.: 17/070,410

(22) Filed: Oct. 14, 2020

Related U.S. Application Data
(60) Provisional application No. 62/914,785, filed on Oct. 14, 2019.

(51) Int. Cl. G02B 27/00; G02B 27/01

(52) U.S. Cl. CPC G02B 27/0031; G02B 27/017; G02B 27/0093

(57) ABSTRACT

Scheduling image composition in a processor based on overlapping of an image composition process and image scan-out operation for displaying an image is disclosed. The processor is configured to periodically schedule a composition process to generate composition passes on the received eyebuffers to generate a display-corrected image for scan-out to a display device. To reduce the motion-to-photon latency, the processor is configured to delay scheduling of the composition process to be closer in time to the scan-out deadline such that there is an overlap in execution of the composition process at the scan-out deadline and image scan-out operation. The scheduling of the composition process can be delayed to only generate a desired number of display lines for the display-corrected image before the scan-out deadline such that lines of the display-corrected image can continue to be available faster than needed for scanning out by the image scan-out operation without scan-out delay.

### PRIORITY CLAIM

The present application claims priority under 35 U.S.C. § 119(e) to U.S. Provisional Patent Application Ser. No. 62/914,785, filed on Oct. 14, 2019 and entitled “SCHEDULING PROCESS PREEMPTION IN A PROCESSOR BASED ON OVERLAPPING OF AN IMAGE COMPOSITION PROCESS AND A SCAN-OUT OPERATION FOR DISPLAYING A COMPOSED IMAGE WITH REDUCED LATENCY,” the contents of which is incorporated herein by reference in its entirety.

### BACKGROUND

### I. Field of the Disclosure

The technology of the disclosure relates generally to virtual reality (VR) or augmented reality (AR), and more particularly to adjusting an image to be displayed on a VR display or AR display.

### II. Background

Computing devices may be used for virtual reality (VR) and/or augmented reality (AR) applications. For example, a VR computing device and a camera-see-through AR device can display an imaged real world object on a screen along with computer generated information, such as an image or textual information. As another example, an AR glasses device, such as a head-mounted AR glasses device, allows the user to see the real world with objects added by a computing device. VR and AR can be used to provide information, either graphical or textual, about a real world object, such as a building or product. Typically, the location or other surrounding objects are not considered when rendering a VR object. However, in AR, the location and other surrounding objects are present for the real world when rendering an AR image. Mobile computing devices can be used as computing devices for VR and/or AR while also providing users with access to a variety of information via wireless communication systems.

VR and/or AR computing devices are conventionally configured to generate a composition pass which takes one or more content layers (referred to as “eyebuffer information” or “eyebuffers”) that need to be display-corrected and composed together such that they can be displayed on a display device. An example of a display device is a head-mounted device (HMD) 100 like shown in FIG. 1. For example, the HMD 100 in FIG. 1 includes a processor 102 configured to generate the composition pass based on received eyebuffer information from another VR and/or AR computing device. The processor 102 may also be responsible for generating eyebuffers as well. The composition pass, which is sometimes referred to as “timewarp” in the context of performing a motion correction, may consist of one or more of the following processing steps for each layer: a lens/optics correction (e.g., chromatic aberration correction (CAC), mura, vignette, etc.), a motion correction (e.g., timewarp, spacewarp, etc.), a reconstruction (e.g., sparse foveation, cubemap, cylindrical projection, etc.), and color conversion (e.g., to or from planar, high dynamic range (HDR), tone-mapping, etc.). The composition pass may schedule to be executed asynchronously to the generation of eyebuffer layers but must be done ahead of strict DPU scan-out timing deadline to display. Hence, conventionally, the composition pass is scheduled ahead of the moment the display processing unit (DPU) needs to start scan-out to the display to achieve low motion-to-photon latency. However, in a system where composition is processed on a shared rendering resource (e.g., a graphics processing unit (GPU), central processing unit (CPU), digital signal processor (DSP), or other processor), there are multiple devices competing for the shared resource. This may affect the ability of the composition to be scheduled sufficiently well ahead of the moment the DPU needs to start scan-out to the display to guarantee composition is completed in time.

### SUMMARY OF THE DISCLOSURE

Aspects disclosed herein include scheduling image composition in a processor based on overlapping of an image composition process and an image scan-out operation for displaying a composed image. The processor may be used for a computing device that is configured to generate and display an image for a virtual reality (VR) and/or augmented reality (AR) application. The processor is configured to periodically schedule and execute a composition process to generate a composition pass based on received eyebuffers to compose a display-corrected image for a VR and/or AR application. The display-corrected image is then periodically scanned out to a display device by an image scan-out operation to be displayed based on a periodic scan-out deadline, such as sixty (60) Hertz (Hz) for sixty (60) frames per second (fps) for example. The processor schedules the composition process sufficiently ahead of the scan-out deadline so that the composition process has sufficient time to process the eyebuffer(s) before the scan-out deadline to generate the display-corrected image to be displayed. However, the sooner the composition process is scheduled to generate the display-corrected image to be displayed, the greater the motion-to-photon latency becomes. The motion-to-photon latency is the delay between the latest motion information available in the eyebuffer(s) and the display of the display-corrected image on a display device.

To reduce the motion-to-photon latency, the processor is configured to schedule the composition process ahead of the scan-out deadline. The scheduling of the composition process could be scheduled sufficiently early to allow the composition process to fully complete the generation of the display-corrected image before the scan-out deadline. However, the motion-to-photon latency in the scanned out display-corrected image increases as a function of earlier scheduling of the composition process. Thus, to minimize the motion-to-photon latency, exemplary aspects disclosed herein include delaying scheduling of the composition process to be closer in time to the scan-out deadline such that there is an overlap in execution of the composition process with the scan-out deadline and image scan-out operation. The scheduling of the composition process can be delayed by the amount of time for the composition process to only generate a desired number of display lines for the display-corrected image before the scan-out deadline. The display-corrected image generated and buffered by the composition process before the scan-out deadline can be used by the image scan-out operation to start the scan-out of the display-corrected image to a display device so that the image scan-out operation is not delayed. The scheduling of the composition process can be determined based on the time when lines of the display-corrected image need to start being initially generated such that lines of the display-corrected image are generated faster than when needed to be scanned out by the image scan-out operation without scan-out delay. This is referred to as “racing-the-raster” or “beam-racing.” In this manner, the composition process, while delayed to further reduce motion-to-photon latency, is still scheduled sufficiently early before the scan-out deadline to generate lines of the display-corrected image before they need to be ready to be scanned out by the image scan-out operation without scan-out delay.

Thus, the scheduling of the composition process does not have to be scheduled earlier to allow the composition process to complete the composition pass before the scan-out deadline. The composition process can continue to generate additional display-corrected image made available to be scanned out after the scan-out deadline and in time to be ready to be scanned-out by the image scan-out operation. In examples disclosed herein, the delayed scheduling of the composition process can be based on a deterministic rate for the composition process to generate a line of the display-corrected image. This deterministic rate can then be compared to the rate at which the lines of the display-corrected image are scanned-out by the image scan-out operation. The composition process is scheduled in time to continue to generate lines of display-corrected image ahead of when needed for scan-out by the image scan-out operation. This scheduling of the composition process can also be based on other factors that add delay to generating lines of the display-corrected image, such as the overhead in scheduling a process in the processor. Further, if the processor is configured as a shared processor responsible for both image rendering and composition, the scheduling of the composition process can also be based on the preemption time for the processor to preempt the rendering process and swap in the composition process for execution.

In this regard, in one exemplary aspect, a processor is provided. The processor is configured to execute a composition process to generate the display-corrected image based on an eyebuffer. The processor is also configured to execute an image scan-out operation to cause a display-corrected image to be scanned out to a display device starting at a scan-out deadline. The processor is configured to start execution of the composition process at a schedule time to generate a desired number of lines of the display-corrected image prior to the scan-out deadline. The processor is configured to continue the execution of the composition process to generate a remaining number of lines from the display-corrected image after the scan-out deadline and overlapping in execution of the image scan-out operation.

In another exemplary aspect, a method of executing a composition process in a processor for generating a display-corrected image to be scanned out to a display device is provided. The method includes scanning out a display-corrected image starting at a scan-out deadline to a display device. The method also includes starting to execute a composition process at a schedule time to generate a desired number of lines of the display-corrected image based on an eyebuffer prior to the scan-out deadline. The method also includes continuing to execute the composition process to generate a remaining number of lines from the display-corrected image after the scan-out deadline and overlapping in time with the scanning out of the display-corrected image after the scan-out deadline.

In another exemplary aspect, a non-transitory computer-readable medium is provided. The non-transitory computer-readable medium has stored thereon computer executable instructions which, when executed, cause a processor to start execution of a composition process at a schedule time to generate a desired number of lines of the display-corrected image based on an eyebuffer prior to a scan-out deadline at which the display-corrected image starts to be scanned out to a display device. The instructions also cause the processor to continue the execution of the composition process to generate a remaining number of lines from the display-corrected image after the scan-out deadline and overlapping in time with the scanning out of the display-corrected image after the scan-out deadline.

### BRIEF DESCRIPTION OF THE FIGURES

FIG. 1 is a schematic diagram of an exemplary head-mounted display device that can include a processor configured to execute a composition pass based on a received eyebuffer(s) to generate a display-corrected image to be displayed;

FIG. 2A is a scheduling diagram illustrating scheduling of a composition process in a processor to latch an eyebuffer(s) and complete generation of a display-corrected image of the eyebuffer(s) before a scan-out deadline of an image scan-out operation that displays the display-corrected image to a display device;

FIG. 2B is a scheduling diagram illustrating delayed scheduling of the composition process in FIG. 2A to generate a desired portion of the display-corrected image of an eyebuffer(s) before a scan-out deadline and with overlap with an image scan-out operation displaying a display-corrected image, to reduce motion-to-photon latency while avoiding or reducing scan-out delay;

FIG. 3 is a schematic diagram of an exemplary processor-based system that includes a processor including one or more central processing units (CPUs), wherein the processor can be configured to schedule and execute the composition process in FIG. 2B to generate a display-corrected image with reduced motion-to-photon latency while avoiding or reducing scan-out delay;

FIG. 4 is a flowchart illustrating an exemplary process of delayed scheduling of the composition process in FIG. 2B in the processor in FIG. 3 based on an estimated time for the composition process to generate a desired number of display lines in the display-corrected image before a scan-out deadline, such that the display-corrected image can be scanned-out to a display device without scan-out delay;

FIG. 5A is a scheduling diagram illustrating scheduling preemption in a shared processor between an image rendering process as a current process for generating an eyebuffer(s) and a composition process for generating a display-corrected image from an eyebuffer(s), wherein scheduling preemption is based on a composition process completing generation of a display-corrected image before a scan-out deadline of an image scan-out operation that displays the display-corrected image to a display device;

FIG. 5B is a scheduling diagram illustrating the scheduling preemption in a shared processor between the image rendering process and the composition process in FIG. 5A based on delayed eyebuffer(s) latching;

FIG. 5C is a scheduling diagram illustrating delayed scheduling preemption in a shared processor between the image rendering process and the composition process in FIG. 5A, wherein the composition process is configured to generate a desired portion of the display-corrected image of an eyebuffer(s) before a scan-out deadline and with overlap with an image scan-out operation displaying a display-corrected image, to reduce motion-to-photon latency while avoiding or reducing scan-out delay;

FIG. 6 is a flowchart illustrating an exemplary process of delayed scheduling of the composition process in FIG. 5C based on an estimated time for the composition process to generate a desired number of display lines in the display-corrected image before a scan-out deadline, such that the display-corrected image can be scanned-out to a display device without scan-out delay; and

FIG. 7 is a block diagram of an exemplary processor-based system that includes a processor including, but not limited to, the processor in FIG. 3, and configured to schedule a composition process, including the composition processes in FIGS. 2B and 5C, to generate a desired portion of the display-corrected image of an eyebuffer(s) before a scan-out deadline and with overlap with an image scan-out operation displaying a display-corrected image, to reduce motion-to-photon latency while avoiding or reducing scan-out delay.

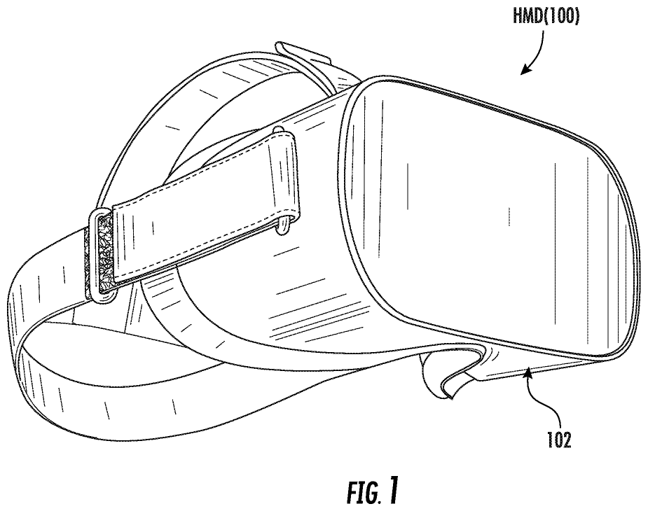

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed herein include scheduling image composition in a processor based on overlapping of an image composition process and an image scan-out operation for displaying a composed image. The processor may be used for a computing device that is configured to generate and display an image for a virtual reality (VR) and/or augmented reality (AR) application. The processor is configured to periodically schedule and execute a composition process to a generate composition pass based on received eyebuffers to compose a display-corrected image for a VR and/or AR application. The display-corrected image is then periodically scanned out to a display device by an image scan-out operation to be displayed based on a periodic scan-out deadline, such as sixty (60) Hertz (Hz) for sixty (60) frames per second (fps) for example. The processor schedules the composition process sufficiently ahead of the scan-out deadline so that the composition process has sufficient time to process the eyebuffer(s) before the scan-out deadline to generate the display-corrected image to be displayed. However, the sooner the composition process is scheduled to generate the display-corrected image to be displayed, the greater the motion-to-photon latency becomes. The motion-to-photon latency is the delay between the latest motion information available in the eyebuffer(s) and the display of the display-corrected image on a display device.

To reduce the motion-to-photon latency, the processor is configured to schedule the composition process ahead of the scan-out deadline. The scheduling of the composition process could be scheduled sufficiently early to allow the composition process to fully complete the generation of the display-corrected image before the scan-out deadline. However, the motion-to-photon latency in the scanned out display-corrected image increases as a function of earlier scheduling of the composition process. Thus, to minimize the motion-to-photon latency, exemplary aspects disclosed herein include delaying scheduling of the composition process to be closer in time to the scan-out deadline such that there is an overlap in execution of the composition process with the scan-out deadline and image scan-out operation. The scheduling of the composition process can be delayed by the amount of time for the composition process to only generate a desired number of display lines for the display-corrected image before the scan-out deadline. The display-corrected image generated and buffered by the composition process before the scan-out deadline can be used by the image scan-out operation to start the scan-out of the display-corrected image to a display device so that the image scan-out operation is not delayed. The scheduling of the composition process can be determined based on the time when lines of the display-corrected image need to start being initially generated such that lines of the display-corrected image are generated faster than when needed to be scanned out by the image scan-out operation without scan-out delay. This is referred to as “racing-the-raster” or “beam-racing.” In this manner, the composition process, while delayed to further reduce motion-to-photon latency, is still scheduled sufficiently early before the scan-out deadline to generate lines of the display-corrected image before they need to be ready to be scanned out by the image scan-out operation without scan-out delay.

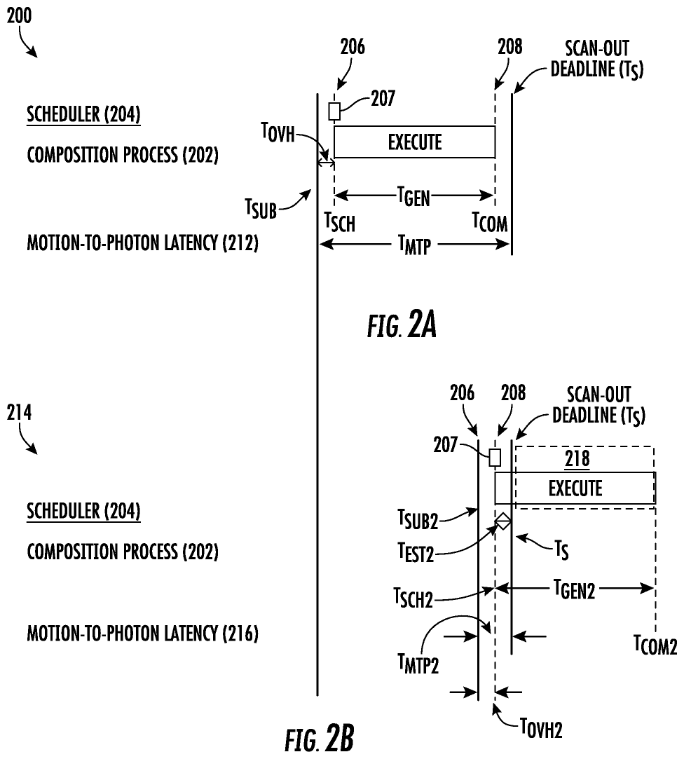

Examples of delayed scheduling of a composition process in a processor based on overlapping of the execution of the composition process at a scan-out deadline for an image scan-out operation starts at FIG. 2B below. However, before discussing FIG. 2B, an example of scheduling of a composition process in a processor to be completed before the scan-out deadline is first discussed with regard to FIG. 2A.

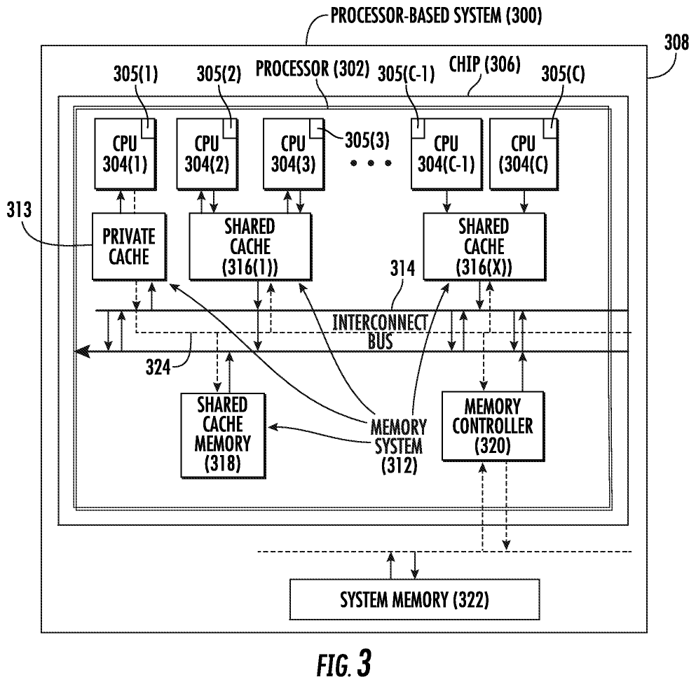

In this regard, FIG. 2A is a scheduling diagram 200 illustrating scheduling of a composition process 202 in a processor, such as processor 302 discussed in FIG. 3 below. The scheduling diagram 200 illustrates a scheduler 204 that is configured to latch an eyebuffer 206 in its latest pose as a latched eyebuffer 207 and complete generation of a display-corrected image 208 of the latched eyebuffer 207 before a scan-out deadline T_{S}. The eyebuffer 206 is one or more content layers of generated information by a VR or AR device about the imaged environment as a user would see. An eyebuffer can be referred to as “eyebuffer information” or “eyebuffers.” The processor 302 can latch the eyebuffer 206 as the latched eyebuffer 207. Latching the eyebuffer 206 involves obtaining a stored snapshot in memory of a current state of the eyebuffer 206. The scheduler 204 may be a scheduler circuit in an instruction processing circuit of a processor or a software process that is executed by the kernel of an operation system, as examples. The scan-out deadline may be configured to occur on a schedule of sixty (60) times a second, as an example. Scanning out of the display-corrected image 208 to a display device, such as by a display graphics processor unit (DPU), in an image scan-out operation begins starting at the scan-out deadline T_{S}. In this example, the eyebuffer 206 that is latched as the latched eyebuffer 207 is generated by rendering operation or process in a separate processor from the processor that schedules and executes the composition process 202. The scan-out deadline T_{S} is the time at which the display-corrected image 208 generated by execution of the scheduled composition process 202 is scanned out to a display device.

The composition process 202 does not execute until the scheduler 204 schedules the composition process 202 to be executed. In this regard, the scheduler 204 or processor that includes the scheduler 204 can be configured to estimate the completion time needed for the composition process 202 to complete the generation of the display-corrected image 208 from the latched eyebuffer 207 ahead of the scan-out deadline T_{S}. The scheduler 204 uses the estimated completion time to determine when the scheduler 204 is to schedule the composition process 202 ahead of the scan-out deadline T_{S} so that the composition process 200 is completed ahead of the scan-out deadline T_{S}. In this example, the scheduler 204 estimates that it will take the generation time T_{GEN} for the composition process 202 to be completed. In this regard, the scheduler 204 schedules the composition process 202 to be executed at least the estimated generation time T_{GEN} before the scan-out deadline T_{S}. The scheduler 204 schedules the composition process 202 to be executed at schedule time T_{SCH} in FIG. 2A so that the composition process 202 will be completed at time T_{COM} on or before the scan-out deadline T_{S}. In the example in FIG. 2A, the scheduler 204 can schedule the composition process 202 before schedule time T_{SCH} at a submission time T_{SUB} so that overhead time T_{OVH} associated with the scheduler 204 scheduling the composition process 202 to be executed can be taken into consideration when scheduling so that the composition process 202 will begin to execute at schedule time T_{SCH}.

Note that it may not be exactly known to the scheduler 204 how long it will take to for the composition process 202 to be completed given the variability in processor performance. Thus, as shown in FIG. 2A, the scheduler 204 in this example scheduled the composition process 202 such that the composition process 202 is completed at time T_{COM} before the scan-out deadline T_{S}. This could be due to the scheduler 204 scheduling the composition process 202 earlier to ensure that it is completed before the scan-out deadline T_{S} given the variability in processor performance. As shown in FIG. 2A, the motion-to-photon latency (i.e., delay) 212 is time T_{MTP} between the latching of the eyebuffer 206 as latched eyebuffer 207 at schedule time T_{SCH} and the scan-out deadline T_{S}. In other words, once the eyebuffer 206 is latched, the latched eyebuffer 207 used to generate the display-corrected image 208 is not updated for at least the time that the composition process 202 executes to complete the generation of the display-corrected image 208.

FIG. 2B is a scheduling diagram 214 illustrating the delayed scheduling of the composition process 202 in a processor such that execution of the composition process 202 overlaps with an image scan-out operation that starts at the scan-out deadline T_{S} to reduce motion-to-photon latency. As discussed in more detail below, this reduces motion-to-photon latency 216 of the scan-out of the display-corrected image 208 as compared to the motion-to-photon latency 212 in FIG. 2A, wherein the composition process 202 is scheduled sufficiently ahead of the scan-out deadline T_{S} to be completed before the scan-out deadline T_{S}. By delayed scheduling of the composition process 202 such that the composition process 202 will be executed overlapped with an image scan-out operation that starts at the scan-out deadline T_{S}, the motion-to-photon latency 216 of the display-corrected image 208 is reduced to time T_{MTP2} as compared to time T_{MTP} for motion-to-photon latency 212 in FIG. 2A. This is because the latching of the eyebuffer 206 as the latched eyebuffer 207 by the scheduler 204 as shown in the scheduling diagram 214 in FIG. 2B is delayed until closer to the scan-out deadline T_{S}. As discussed below, the delayed scheduling of the composition process 202 can be done in a way that still allows the composition process 202 to generate a portion of the display-corrected image 208 ahead of the scan-out deadline T_{S} and continue to generate a portion of the display-corrected image 208 after of the scan-out deadline T_{S}, but in time for the image scan-out operation to continue to scan-out the display-corrected image 208 without interruption or delay.

With reference to FIG. 2B, in this example, the scheduler 204 is configured to estimate the completion time needed for the composition process 202 to generate a portion of the display-corrected image 208 before the scan-out deadline T_{S} so that a portion of the display-corrected image 208 is available to be scanned out in the image scan-out operation without interruption or delay. In one example, the scheduler 204 is configured to estimate the completion time needed for the composition process 202 to generate a portion of the display-corrected image 208 before the scan-out deadline T_{S} by estimating the desired number of display lines in the display-corrected image 208 needed to be generated before the scan-out deadline T_{S}. The desired number of display lines is based on the speed in which the composition process 202 needs to generate the display-corrected image 208 in sufficient time for the scan-out task to not be delayed once started at the scan-out deadline T_{S}. In other words, a sufficient amount of the display-corrected image 208 is available from the composition process 202 ahead of the time to be scanned out without delay and without the composition process 202 having to complete the generation of the complete display-corrected image 208 before the scan-out deadline T_{S}. In this manner, as shown in FIG. 2B, the execution of the composition process 202 overlaps in time as shown by overlap window 218 with the scan-out deadline T_{S} starting at scan-out deadline T_{S} and the scanning out of the display-corrected image 208 previously generated (i.e., buffered) by the composition process 202.

The number of display lines can be based on a deterministic rate in which the display-corrected image 208 generated by the composition process 202 can continue to be generated faster than scanned out by the image scan-out operation so that there is no delay in the image scan-out operation. This may be referred to as “racing-the-raster” or “beam-racing.” Buffering of display lines of the display-corrected image 208 generated by the composition process 202 allows a processor to finish work on ‘L’ lines in scan line (top to bottom) order for example. The processor may buffer ‘L’ lines at a time based on caching and other architectural requirements. An image scan-out operation to scan out the lines of the display-corrected image 208 to a display device can be performed by reading blocks of ‘M’ lines of the display-corrected image 208 at a time based on caching or other architectural requirements for example. For example, ‘N’ number of lines of the display-corrected image 208 are taken as the maximum between ‘L’ lines and ‘M’ lines above. As shown in FIG. 2B, the composition process 202 is scheduled ahead of the scan-out deadline T_{S}, so there is an assumption that the composition process 202 can run faster than an image scan-out operation to scan out the display-corrected image 208 to a display device. In one example, the ‘N’ number of lines that is generated by composition process 202 before scan-out deadline T_{S} is a relatively small amount of the total lines of the display-corrected image 208, and hence the composition process 202 has to race ahead of the image scan-out operation.

With continuing reference to FIG. 2B, the scheduler 204 uses the estimated completion time to determine when the scheduler 204 should be scheduled ahead of the scan-out deadline T_{S}. In this example, the scheduler 204 estimates that it will take time T_{EST2} for the composition process 202 to generate the desired number of lines of the display-corrected image 208 before the scan-out deadline T_{S} so that the image scan-out operation can continue to scan-out lines of the display-corrected image 208 without delay. In this regard, the scheduler 204 schedules the composition process 202 to be executed starting at least as early as the estimated generation time T_{GEN2} before the scan-out deadline T_{S}. The scheduler 204 schedules the composition process 202 to be executed at schedule time T_{SCH2} in FIG. 2B so that the composition process 202 will generate the desired number of lines of the display-corrected image 208 on or before the scan-out deadline T_{S}. In the example in FIG. 2B, the scheduler 204 can schedule the composition process 202 before the schedule time T_{SCH2} at an earlier submission time T_{SUB2} so that overhead associated with the scheduler 204 scheduling the composition process 202 to be executed can be taken into consideration when scheduling so that the composition process 202 will begin to execute at schedule time T_{SCH2}. The overhead associated with the scheduler 204 scheduling the composition process 202 to be executed is shown as overhead time T_{OVH2}.

Note that it may not be exactly known to the scheduler 204 how long it will take to for the composition process 202 to generate the desired number of lines of the display-corrected image 208. Thus, as shown in FIG. 2B, the scheduler 204 in this example scheduled the composition process 202 such that the composition process 202 completed at time T_{COM2} after the scan-out deadline T_{S} so that the display-corrected image 208 is generated by the composition process 202 faster than scanned out by the image scan-out operation so that there is no delay in the scan-out. As shown in FIG. 2B, the motion-to-photon latency 216 is the time T_{MTP2} between the latching of the eyebuffer 206 as latched eyebuffer 207 at schedule time T_{SCH} and the scan-out deadline T_{S}, which is significantly less than the motion-to-photon latency 212 of time T_{MTP} in FIG. 2A. In other words, once the eyebuffer 206 is latched, the latched eyebuffer 207 used to generate the display-corrected image 208 is not updated before being scanned out only for the motion-to-photon latency 216 of time T_{MTP2} that the composition process 202 executes to generate the desired number of lines of the display-corrected image 208 before the scan-out deadline T_{S}.

FIG. 3 is a schematic diagram of an exemplary processor-based system 300 that includes a processor 302 including one or more central processing units (CPUs) 304(1)-304(C) that can include respective schedulers 305(1)-305(C), such as scheduler 204, configured to schedule and delay scheduling of a composition process, such as the composition process 202 in FIG. 2B, based on overlapping of the execution of the composition process 202 at a scan-out deadline for an image scan-out operation. For examples, the schedulers 305(1)-305(C) may be hardware schedule circuits that are included in the instruction processing circuits of the respective CPUs 304(1)-304(C) to schedule processes. The schedulers 305(1)-305(C) could also be software schedulers that are included in an operating system executed on a respective CPU 304(1)-304(C), for example, to schedule processes. The scheduler 305(1)-305(C) for one of the CPUs 304(1)-304(C) may be a master scheduler that schedules processes for all of the CPUs 304(1)-304(C) as part of an overall operating system for the processor 302 as another example.

In this example, the processor 302 is included on a separate semiconductor die or integrated circuit (IC) chip 306 which can be packaged in a multi-chip package 308. The processor 302 in this example includes a corresponding hierarchal memory system 312 that is configured to store program code to be executed by a CPU 304(1)-304(C) and data for read and write access by the CPUs 304(1)-304(C). The hierarchal memory system 312 can also store data that includes eyebuffer(s), such as latched eyebuffer 207 in FIG. 2B, that are latched and then processed by the composition process, such as the composition process 202 in FIG. 2B, when scheduled by a scheduler 305(1)-305(C).

With continuing reference to FIG. 3, the hierarchal memory system 312 contains memory components configured to store data and be accessed by requesting CPUs 304(1)-304(C) for memory access requests. For example, processor 302 has a memory system 312 that includes a private local cache memory 313 for CPU 304(1), which may be a Level 2 (L2) cache memory, for example. If a memory read request requested by CPU 304(1) results in a cache miss to the private local cache memory 313, then the memory read request is forwarded by an internal interconnect bus 314 to a local shared cache memory 316(1) as part of the memory system 312 in the processor 302, where ‘X’ represents a positive whole number of the number of shared cache memories 316(1)-316(X). The internal interconnect bus 314, which may be a coherent bus, that is provided allows each of the CPUs 304(1)-304(C) in the processor 302 to access the local shared cache memories 316(1)-316(X) and other shared resources coupled to the interconnect bus 314.

If a memory read request requested by a CPU 304(1)-304(C) results in a cache miss to the local shared cache memory 316(1)-316(X), the memory read request is forwarded by the interconnect bus 314 to a next level shared cache memory 318 as part of the memory system 312 in the processor 302. The shared cache memory 318 may be a Level 3 (L3) cache memory as an example. If a memory read request requested by a CPU 304(1)-304(C) further results in a cache miss to the shared cache memory 318, the memory read request is forwarded by the interconnect bus 314 to a memory controller 320 that is communicatively coupled to a system memory 322 as a main memory in the processor-based system 300.

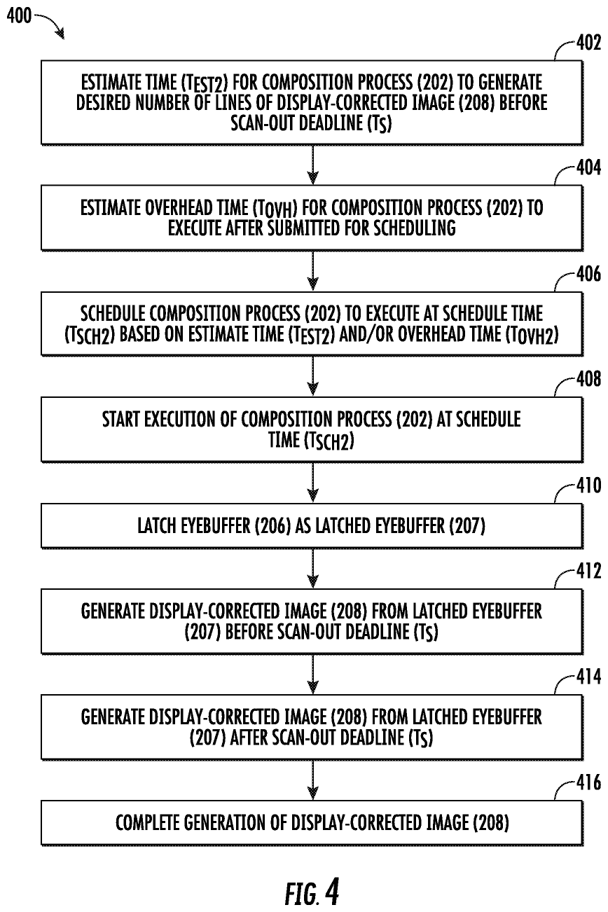

FIG. 4 is a flowchart illustrating an exemplary process 400 of a processor, such as processor 302 in FIG. 3, and/or its scheduler, like scheduler 204 in FIG. 2B or schedulers 305(1)-305(C) in FIG. 3, configured to schedule and delay scheduling of a composition process based on overlapping of the execution of the composition process 202 at a scan-out deadline for an image scan-out operation. The delayed scheduling discussed in process 400 is discussed with regard to the scheduling of the composition process 202 in FIG. 2B by the scheduler 204 therein.

In this regard, the processor 302 and/or its respective scheduler 305(1)-305(C) is configured to determine the submission time T_{SUB2} by which the composition process 202 should be submitted for scheduling for execution so that the composition process 202 generates a desired number of lines of the display-corrected image 208 before the scan-out deadline T_{S}. In this regard, in this example, the processor 302 and/or its scheduler 305(1)-305(C) is configured to determine the estimated time T_{EST2} for the composition process 202 to generate a desired number of lines of the display-corrected image 208 before the scan-out deadline T_{S} (block 402 in FIG. 4). In this example, the processor 302 and/or its scheduler 305(1)-305(C) can be configured to determine the estimated overhead time T_{OVH} for the composition process 202 to execute after being submitted for scheduling to be executed (block 404 in FIG. 4). For example, the overhead time T_{OVH2} may be based on an estimate of the time associated with the overhead for the scheduler 204 to schedule the composition process 202 for execution after submission of scheduling. In this example, the scheduler 204 then schedules the composition process 202 for execution at submission time T_{SUB2} based on the estimated time T_{EST2} for the composition process 202 to generate a desired number of lines of the display-corrected image 208 before the scan-out deadline T_{S} and/or the overhead time T_{OVH} between the submission of scheduling of the composition process 202 and the start of its execution (block 406 in FIG. 4).

With continuing reference to FIG. 4, the composition process 202 then starts execution at its schedule time T_{SCH2} based on the determined submission time T_{SUB2} at which the composition process 202 is submitted for scheduling by the scheduler 204 (block 408 in FIG. 4). The composition process 202 can latch the eyebuffer 206 as the latched eyebuffer 207 (block 410 in FIG. 4). The composition process 202 continues to execute to start to generate lines of the display-corrected image 208 from the eyebuffer 206 or latched eyebuffer 207, which is before the scan-out deadline T_{S} according to the submission time T_{SUB2} that the composition process 202 was submitted for scheduling by the scheduler 204 (block 412 in FIG. 4). The composition process 202 continues to generate lines of the display-corrected image 208 from the eyebuffer 206 or latched eyebuffer 207 after the scan-out deadline T_{S} when the image scan-out operation begins scanning out completed lines of the generated display-corrected image 208 to a display device (block 414 in FIG. 4). In this regard, the execution of composition process 202 overlaps with the scan-out deadline T_{S} and the image scan-out operation. The composition process 202 continues to generate lines of the display-corrected image 208 from the eyebuffer 206 or latched eyebuffer 207 until the display-corrected image 208 is completed (block 416 in FIG. 4).

The submission time T_{SUB2} for the processor 302 or scheduler 204 is the time to or by which to submit the composition process 202 in FIG. 2B so that the image scan-out operation does not have to be delayed. The submission time T_{SUB2} to submit the composition process 202 is based on a time so that the composition process 202 can generate the desired number of lines of the display-corrected image 208 before the scan-out deadline T_{S}. In this regard, the composition process 202 executes overlapped with the image scan-out operation. The submission time T_{SUB2} can be statically programmed or dynamically determined. In one example, when calculating the submission time T_{SUB2} for the composition process 202 in FIG. 2B to be submitted, as discussed above, the generation time T_{GEN2} for the composition process 202 to generate a designated number of lines of the display-corrected image 208 before the scan-out deadline T_{S} is used. The estimated time T_{EST2} for the composition process 202 to generate a designated number of lines of the display-corrected image 208 before the scan-out deadline T_{S} can be based on the least or a given number of lines of the display-corrected image 208 that have to be generated before the scan-out deadline T_{S} so that lines of the display-corrected image 208 are available to continue to be scanned out by the image scan-out operation. Also, when calculating the submission time T_{SUB2} for the composition process 202 in FIG. 2B to be submitted, as discussed above, the overhead time T_{OVH} between submission of the composition process 202 and the execution of the composition process 202 at schedule time T_{SCH2} can be used.

These estimated times can be based on a static profiling of the processor 302 and scheduler 204 to determine a distribution of the overhead time T_{OVH2} for scheduling the composition process 202 for execution and the estimated time TEST for the number of lines of the display-corrected image 208 that needs to be generated before the scan-out deadline T_{S} so that lines of the display-corrected image 208 are available to continue to be scanned out by the image scan-out operation without delay. Alternatively, the estimated time TEST can be based on monitoring a dynamic distribution in real-time operation of the overhead time T_{OVH2} and the estimated time T_{EST2} it takes for the processor 302 and scheduler 204 to generate a number of lines of the display-corrected image 208 so that lines of the display-corrected image 208 are available to continue to be scanned out by the image scan-out operation. The static and dynamic profiling options for the estimated time T_{EST2} can be based on a worst, average, or best case scenarios of the distribution of estimated time T_{EST2}. For example, the worst case estimated time T_{EST2} and overhead time T_{OVH2} could be added together to determine the schedule time T_{SCH2}. However, it may be acceptable for a small number of lines or frames of the display-corrected image 208 to not be scanned out properly or on time such that the schedule time T_{SCH2} may be best on timing that is less than worst case estimates. This can eliminate very rare outlier situations which could push out the motion-to-photon latency 216.

For systems which have the dynamic monitoring available, this could even vary based on if composition process 202 is missing frames of the display-corrected image 208 by not generating them far enough in advance of the scan-out deadline T_{S}. If too may frames or lines of the display-corrected image 208 are being missed, the schedule time T_{SCH2} can be moved earlier before the scan-out deadline T_{S}. The static and/or dynamic profiling options can also be based on the performance of the processor 302 as another example.

Note that a processor, such as processor 302 in FIG. 3, can also be configured as a shared processor responsible for both image rendering and image composition. In this regard, the processor 302 may execute an operating system that can schedule both an image rendering process to generate an eyebuffer(s), such as eyebuffer 206 in FIG. 2B, and an composition process, such as composition process 202, to generate a display-corrected image from the eyebuffer(s). In this regard, using the example of the processor 302 in FIG. 3, a scheduler 305(1)-305(C) preempts an image rendering process to schedule and execute a composition process at periodic times before a scan-out deadline to generate a display-corrected image to be scanned out. Thus, the scheduler 305(1)-305(C) must also take into consideration the preemption time of swapping out an image rendering process for the composition process as part of the scheduling of the composition process.

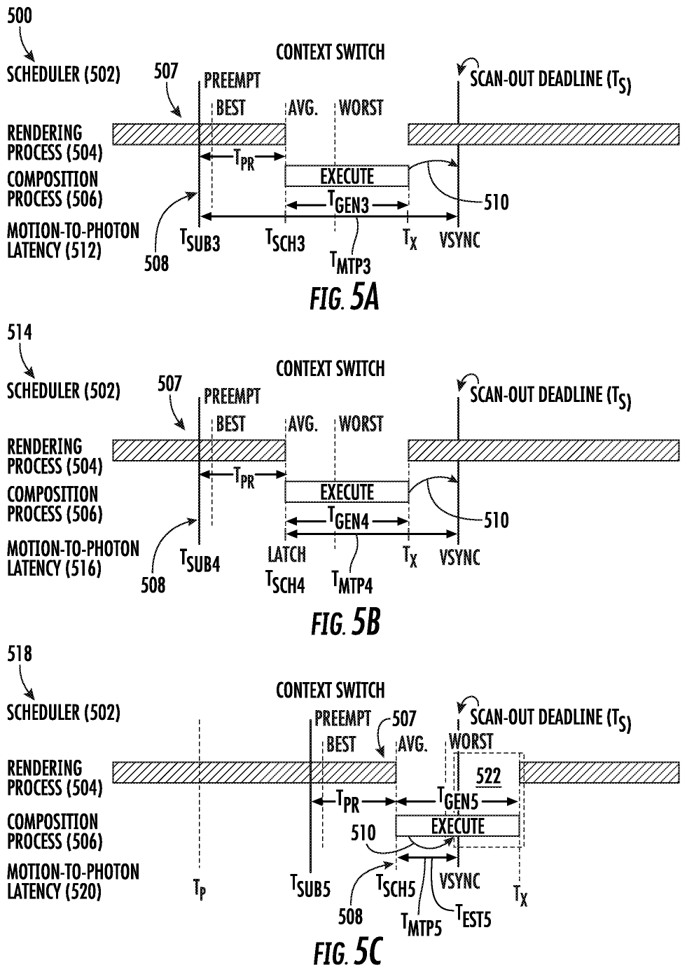

In this regard, FIG. 5A is a scheduling diagram 500 of context switching by a scheduler 502 in a shared processor, such as processor 302 in FIG. 3 between an example image rendering process 504 and a composition process 506. The image rendering process 504 is configured to generate an eyebuffer 507. The eyebuffer 507 is latched as a latched eyebuffer 508. The composition process 506 is configured to generate a display-corrected image 510 based on the latched eyebuffer 508 to be scanned out to a display device by an image scan-out operation of the processor 302 in FIG. 3 as an example. Note that the image rendering process 504 illustrated in FIG. 5A represents a processor processing an image rendering task and/or possibly other tasks. In this regard, the processor has already previously swapped in a new context for the image rendering process 504 as the current process to be executed. The processor executes the image rendering process 504 as a current process to generate an ongoing stream of the eyebuffer 507 comprising at least one context layer of an image to be displayed on a display device starting at a scan-out deadline T_{S}. The scan-out deadline T_{S} may be configured to occur on a schedule of sixty (60) times a second as an example. The scan-out deadline T_{S} is the time at which a display-corrected image 510 generated by execution of a later swapped-in composition process 506 after preemption of the image rendering process 504 is scanned out to a display device. The composition process 506 does not execute until a context switch of the image rendering process 504 is completed. In this regard, the scheduler 502 or processor 302 estimates the preemption time to complete preemption of the image rendering process 504 and the time for the composition process 506 to complete to then schedule the preemption of the image rendering process 504 sufficiently ahead of the scan-out deadline T_{S}.

As shown in FIG. 5A, the scheduler 502 determines preemption time T_{PR} to preempt a currently executing process, which is shown as the image rendering process 504 in this example, with the composition process 506. The scheduler 502 then determines a generation time T_{GEN3} for the composition process 506 to complete generation of the display-corrected image 510 from the latched eyebuffer 508. The schedule time T_{SCH3} is the time that the composition process 506 needs to start executing to complete the generation of the display-corrected image 510 prior to the scan-out deadline T_{S}. The time to complete the generation of the display-corrected image 510 is determined at generation time T_{GEN3}. However, there is a preemption time T_{PR} that is also incurred in preempting a current process to the composition process 506. Thus, the scheduler 502 submits the preemption of the current process to schedule the composition process 506 at a submission time T_{SUB3} based on preemption time T_{PR} and the schedule time T_{SCH3} so that the composition process 506 can complete generation of the display-corrected image 510 from the latched eyebuffer 508 prior to the scan-out deadline T_{S}. In this manner, the composition process 506 is submitted for execution at the submission time T_{SUB3} to account for the preemption time T_{PR} and the schedule time T_{SCH3}. The processor 302 is configured to latch the eyebuffer 507 in its latest pose as a latched eyebuffer 508 that is being generated as a stream by the image rendering process 504 when it is executed based on the preemption of the currently executing process, shown as image rendering process 504, at time T_{P} to provide this information to the composition process 506 to be processed. The composition process 506 is then executed by the processor at the schedule time T_{SCH3} after completion of preemption of the image rendering process 504 in this example to perform a motion correction, for example, on the latched eyebuffer 508.

Note that it is not known exactly what the preemption time T_{PR} will be to complete preemption of the currently executing process to switch in the context of the composition process 506 and start to execute the composition process 506. Thus, a worst case timing of the preemption time T_{PR} may be assumed to guarantee completion of preemption so that composition process 506 completes the generation of the display-corrected image 510 before the scan-out deadline T_{S} can be guaranteed. In the example in FIG. 5A, the preemption time T_{PR} for completion of preemption is an average time based on the workload of the processor 302. At schedule time T_{SCH3}, the composition process 506 starts execution, and its execution completes at time T_{X}. In this example, the processor 302 then switches the context of the image rendering process 504 back in place of the context of the composition process 506 to begin executing the image rendering process 504. Note that the processor could switch another process other than the image rendering process 504 back in place of the context of the composition process 506 after the composition process 506 completes. The display-corrected image 510 generated by the composition process 506 can start to be scanned out by the image scan-out operation to a display starting at the scan-out deadline T_{S}. Thus, as shown in FIG. 5A, the motion-to-photon latency 512 is the time T_{MTP3} between the latching of the eyebuffer 507 as latched eyebuffer 508 at time T_{P} and the scan-out deadline T_{S}.

FIG. 5B is another scheduling diagram 514 of context switching by the scheduler 502 in a processor 302 that is shared to execute both the image rendering process 504 and the composition process 506. In this example, the motion-to-photon latency 516 indicated by time T_{MTP4} is reduced by delaying the latching of the eyebuffer 507 as latched eyebuffer 508 generated by the image rendering process 504 based on the preemption of the image rendering process 504 being completed.

Like the scheduler 502 in FIG. 5A, the scheduler 502 in FIG. 5B determines the preemption time T_{PR} to preempt a currently executing process, which is shown as the image rendering process 504 in this example, with the composition process 506. The scheduler 502 then determines a generation time T_{GEN4} for the composition process 506 to complete generation of the display-corrected image 510 from the latched eyebuffer 508. The schedule time T_{SCH4} is the time that the composition process 506 needs to start executing to complete the generation of the display-corrected image 510 prior to the scan-out deadline T_{S}. However, there is a preemption time T_{PR} that is also incurred in preempting a current process to the composition process 506. Thus, the scheduler 502 submits the preemption of the current process to schedule the composition process 506 at a submission time T_{SUB4} based on preemption time T_{PR} and the schedule time T_{SCH4} so that the composition process 506 can complete generation of the display-corrected image 510 according to a determined generation time T_{GEN4} from the latched eyebuffer 508 prior to the scan-out deadline T_{S}. In this manner, the composition process 506 is submitted for execution at the submission time T_{SUB4} to account for the preemption time T_{PR} and the schedule time T_{SCH4}. The composition process 506 is then executed by the processor at the schedule time T_{SCH4} after completion of preemption of the image rendering process 504 in this example to perform a motion correction, for example, on the latched eyebuffer 508.

FIG. 5C is another scheduling diagram 518 of context switching in the processor 302 that is shared to execute the image rendering process 504 and the composition process 506 such that the composition process 506 executes overlapping at the scan-out deadline T_{S} to further reduce motion-to-photon latency. In this example, the motion-to-photon latency 520 shown as time T_{MTP5} is further reduced over the motion-to-photon latency 516 shown as time T_{MTP4} in the scheduling diagram 514 in FIG. 5B by delaying (i.e., scheduling closer in time to the scan-out deadline T_{S}) the scheduling of preemption of the current process to the composition process 506 from time T_{P} to time T_{PD}. The scheduler 502 delays the preemption of the image rendering process 504 for the composition process 506 to be submitted at submission time T_{SUB5} based on the determined preemption time T_{PR} and/or a determined estimated time T_{EST5} it will take for the composition process 506 to generate a desired number of display lines in the display-corrected image 510 before the scan-out deadline T_{S}. The worst case preemption time for preempting a process can be used to determine the preemption time T_{PR}. In this manner, the execution of the composition process 506 overlaps in time as shown by overlap window 522 at the scan-out deadline T_{S}. Starting at the scan-out deadline T_{S}, the image scan-out operation scans out of the display-corrected image 510 previously generated (i.e., buffered) by the composition process 506. The desired number of display lines of the display-corrected image 510 can be based on the generation rate of lines of the display-corrected image 510 in which the composition process 506 needs to generate the display-corrected image 510 in sufficient time for the image scan-out operation to not be delayed once started at the scan-out deadline T_{S}.

The generation rate of lines of the display-corrected image 510 of the composition process 506 can be compared to the scan out rate of the image scan-out operation to determine how many lines of the display-corrected image 510 need to be generated by the composition process 506 before the scan-out deadline T_{S} and in what estimated time T_{EST5}. The estimated time T_{EST5} is used to determine the schedule time T_{SCH5} of the composition process 506, which is used to determine the submission time T_{SUB5} for preemption of the current process with the composition process 506. In other words, the schedule time T_{SCH5} of the composition process 506 is based on the time for the composition process 506 to generate sufficient amount of lines of the display-corrected image 510 and is ahead of the time before the scan-out deadline T_{S} is to be available and continue to be generated after the scan-out deadline T_{S} so that the image scan-out operation can scan out the display-corrected image 510 without delay.

The number of display lines of the display-corrected image 510 to be generated by the composition process 506 before the scan-out deadline T_{S} can be based on a deterministic rate in which the display-corrected image 510 generated by the composition process 506 can continue to be generated faster than scanned out so that there is no delay in the scan-out. This may be referred to as “racing-the-raster” or “beam-racing.” Buffering of display lines of the display-corrected image 510 generated by the composition process 506 allows a processor to finish work on ‘L’ lines in scan line (top to bottom) order. The processor may buffer L lines at a time based on caching and other architectural requirements. An image scan-out operation to scan out the lines of the display-corrected image 510 to a display device can be performed by reading blocks of ‘M’ lines of the display-corrected image 510 at a time based on caching or other architectural requirements for example. For example, ‘N’ lines of the display-corrected image 510 is taken as the maximum between ‘L’ lines and ‘M’ lines above as an example. As shown in FIG. 5C, the composition process 506 is scheduled ahead of the scan-out deadline T_{S}, so there is an assumption that the composition process 506 can run faster than a scan-out task to scan out the display-corrected image 510 to a display device. In one example, the ‘N’ number of lines that is generated by composition process 506 before scan-out deadline T_{S} is a relatively small amount of the total lines of the display-corrected image 510, and hence the composition process 506 has to race ahead.

Thus, in the scheduling example disclosed in FIG. 5C, preemption of the currently executing process, which is shown as the image rendering process 504 in this example, does not have to be scheduled sufficiently early to allow the composition process 506 to complete the composition pass before the scan-out deadline T_{S} to further reduce the motion-to-photon latency 520. The scan-out of the display-corrected image 510 may be in line order so that scan-out can be performed while the composition process 506 is still executing as shown in the scheduling diagram 518 in FIG. 5C. The motion-to-photon latency 520 shown as T_{MTP5} is reduced by the completion time of the composition process 506 minus the time to generate the number of display lines of the display-corrected image 510. The average motion-to-photon latency 520 is the worst case preemption time minus the average preemption time of the image rendering process 504 plus the time to generate the desired number of display lines of the display-corrected image 510.

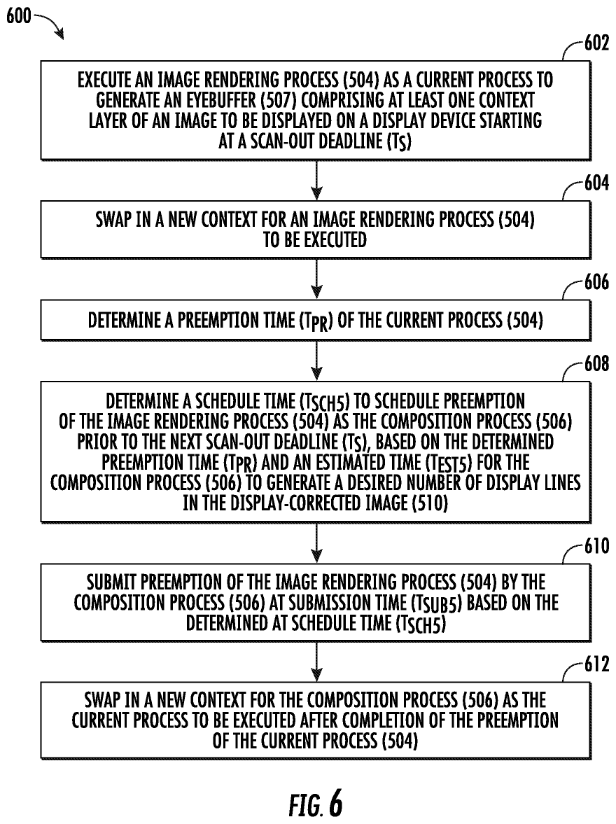

FIG. 6 is a flowchart illustrating an exemplary process 600 of a processor scheduling of the preemption of the image rendering process 504 based on an estimated worst case preemption time and a determined amount of time it will take for the composition process 506 to generate a desired number of display lines in the display-corrected image 510 before a scan-out deadline. The process 600 in FIG. 6 will be discussed in conjunction with the scheduling diagram 518 in FIG. 5C. In this regard, the processor is configured to execute the image rendering process 504 prior to the scheduled preemption time T_{PR} as a current process to generate an eyebuffer 507 comprising at least one context layer of an image to be displayed on a display device (block 602 in FIG. 6). The eyebuffer 507 can be displayed on a display device starting at the scan-out deadline T_{S}. The scheduler 502 is configured to swap in a new context for a current process, which may be the image rendering process 504, to be executed (block 604 in FIG. 6). The image rendering process 504 generates the eyebuffer 507.

With continuing reference to FIG. 6, the scheduler 502 is configured to determine the preemption time T_{PR} to preempt the current process (e.g., the image rendering process 504) with the composition process 506, which may be the worst case preemption time (block 606 in FIG. 6). The scheduler 502 is then configured to determine a schedule time T_{SCH5} to schedule preemption of the current process, which may be the image rendering process 504, by the composition process 506 prior to the next scan-out deadline T_{S}. The schedule time T_{SCH5} may be based on the preemption time T_{PR} to swap out the current process for the composition process 506 and the estimated time T_{EST5} for the composition process 506 to generate a desired number of display lines in the display-corrected image 510 prior to the scan-out deadline T_{S} in this example (block 608 in FIG. 6). The scheduler 502 is then configured to submit preemption of the current process (e.g., the image rendering process 504) by the composition process 506 at submission time T_{SUB5} based on the determined schedule time T_{SCH5} (block 610 in FIG. 6). After the preemption of the current process (e.g., the image rendering process 504) is complete, shown as preemption of the image rendering process 504 at schedule time T_{SCH5} in the example of FIG. 5C, the scheduler 502 is configured to swap in a new context for the composition process 506 as the current process to be executed after completion of the preemption of the current process (e.g., the image rendering process 504) (block 612 in FIG. 6). For example, the image rendering process 504 is swapped back in to be executed after the composition process 506 completes shown by example as time T_{X} in FIG. 5C.

The composition process 506 can then be executed like the previous steps discussed in steps 408-416 in process 400 in FIG. 4, but for the composition process 506 instead of composition process 202.

These estimated preemption time for preemption of the image rendering process 504 by the composition process 506 at time T_{C} in FIG. 5C can be based on a static profiling of the processor 302 and scheduler 502. The estimated preemption time T_{PR} is based on the amount of overhead time it takes to preempt the image rendering process 504 by the composition process 506. The estimated time T_{EST5} is also based on the time need for the composition process 506 to generate an estimated number of lines of the display-corrected image 510 that needs to be generated before the scan-out deadline T_{S}. This is so that lines of the display-corrected image 510 are available to continue to be scanned out by the image scan-out operation without delay. Alternatively, this estimated time T_{EST5} can be based on monitoring a dynamic distribution in real-time operation. The static and dynamic profiling options for the estimated time T_{EST5} can be based on a worst, average, or best case scenarios of the estimated time T_{EST5} and scheduler 502 to generate number of lines of the display-corrected image 510 so that lines of the display-corrected image 510 are available to continue to be scanned out by the image scan-out operation. For example, the worst case estimated time T_{EST5} and time for the composition process 506 to generate an estimated number of lines of the display-corrected image 510 that needs to be generated before the scan-out deadline T_{S} could be added to the determined preemption time T_{PR} to determine the submission time T_{SUB}. However, it may be acceptable for a small number of lines or frames of the display-corrected image 510 to not be scanned out properly or on time such that the preemption time T_{PR} may be best on timing that is less than worst case estimates. This can eliminate very rare outlier situations which could push out the motion-to-photon latency 520.

For systems which have the dynamic monitoring available, this could even vary based on if the composition process 506 is missing frames of the display-corrected image 510 by not generating them far enough in advance of the scan-out deadline T_{S}. If too may frames or lines of the display-corrected image 510 are being missed, the preemption time T_{PR} can be moved earlier before the scan-out deadline T_{S}. The static and/or dynamic profiling options can also be based on the performance of the processor 302 as another example.

A processor configured to schedule an image composition based on overlapping of the image composition process and an image scan-out operation for displaying a display-corrected image, may be provided in or integrated into any processor-based device. Examples, without limitation, include a head-mounted display, a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

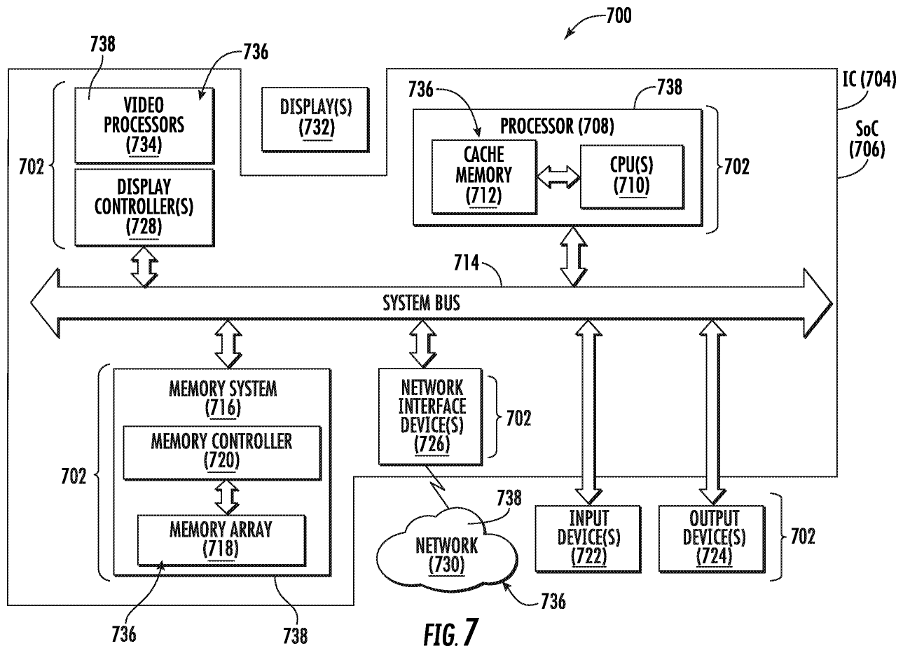

In this regard, FIG. 7 illustrates an example of a processor-based system 700 that can include a processor 702 configured to schedule an image composition process based on overlapping of the image composition process and an image scan-out operation for displaying a display-corrected image which may be provided in or integrated into any processor-based device including, but not limited to, the processor 302 of FIG. 3 as a non-limiting example. In this example, the processor-based system 700 is provided in an IC 704. The IC 704 may be included in or provided as a system on a chip (SoC) 706. The processor-based system 700 includes a processor 708 that includes one or more CPUs 710. The processor 708 can be configured to schedule an image composition processor based on overlapping of the image composition process and an image scan-out operation for displaying a composed image and may be provided in or integrated into any processor-based device including, but not limited to, the processor 302 of FIG. 3 as a non-limiting example. The processor 708 may include a cache memory 712 coupled to the CPU(s) 710 for rapid access to temporarily stored data. The processor 708 is coupled to a system bus 714 and can intercouple master and slave devices included in the processor-based system 700. As is well known, the processor 708 communicates with these other devices by exchanging address, control, and data information over the system bus 714. Although not illustrated in FIG. 7, multiple system buses 714 could be provided, wherein each system bus 714 constitutes a different fabric. For example, the processor 708 can communicate bus transaction requests to a memory system 716 as an example of a slave device. The memory system 716 may include a memory array 718 whose access is controlled by a memory controller 720.

Other master and slave devices can be connected to the system bus 714. As illustrated in FIG. 7, these devices can include the memory system 716, and one or more input devices 722. The input device(s) 722 can include any type of input device, including, but not limited to, input keys, switches, voice processors, etc. The other devices can also include one or more output devices 724, and one or more network interface devices 726 to audio, video, other visual indicators, etc. The other devices can also include one or more display controllers 728 as examples. The network interface device(s) 726 can be any device(s) configured to allow exchange of data to and from a network 730. The network 730 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 726 can be configured to support any type of communications protocol desired.

The processor 708 may also be configured to access the display controller(s) 728 over the system bus 714 to control information sent to one or more displays 732. The display controller(s) 728 sends information to the display(s) 732 to be displayed via one or more video processors 734, which process the information to be displayed into a format suitable for the display(s) 732. The display controller(s) 728 and the video processor(s) 734 can include a processor 702 configured to scheduling an image composition process based on overlapping of the image composition process and an image scan-out operation for displaying a composed image which may be provided in or integrated into any processor-based device including, but not limited to, the processor 302 of FIG. 3 as a non-limiting example. The display(s) 732 can include any type of display, including, but not limited to, a cathode ray tube (CRT), a liquid crystal display (LCD), a plasma display, etc.

The processor-based system 700 in FIG. 7 may include a set of instructions 736 configured to execute the image rendering process and a composition process and schedule preemption of the image rendering process based on an estimated preemption time and/or a determined amount of time it will take for the composition process to generate a desired number of display lines in the display-corrected image before a scan-out deadline. The instructions 736 may be stored in the memory array 718 of the memory system 716, the processor 708, the video processor(s) 734, and the network 730 as examples of non-transitory computer-readable medium 738.

While the computer-readable medium 738 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” can also include any medium that is capable of storing, encoding, or carrying a set of instructions for execution by the processing device and that cause the processing device to perform any one or more of the methodologies of the embodiments disclosed herein. The term “computer-readable medium” includes, but is not be limited to, solid-state memories, optical medium, and magnetic medium.

Those of skill in the art will further appreciate that the various illustrative logical blocks, modules, circuits, and algorithms described in connection with the aspects disclosed herein may be implemented as electronic hardware, instructions stored in memory or in another computer-readable medium and executed by a processor or other processing device, or combinations of both. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design states imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

What is claimed is:

1. A processor configured to:
execute a composition process to generate a display-corrected image based on an eyebuffer;
execute an image scan-out operation to cause the display-corrected image to be scanned out to a display device starting at a scan-out deadline; and
the processor configured to:
start execution of the composition process at a schedule time to generate a desired number of lines of the display-corrected image prior to the scan-out deadline; and
continue the execution of the composition process to generate a remaining number of lines from the display-corrected image after the scan-out deadline and overlapping in execution of the image scan-out operation.

2. The processor of claim 1 configured to execute the composition process to generate the display-corrected image based on a latched eyebuffer.

3. The processor of claim 1, further comprising a scheduler configured to schedule the composition process to start to be executed at the schedule time to start the generation of the desired number of lines of the display-corrected image prior to the scan-out deadline.

4. The processor of claim 3, further configured to determine an estimated time for the composition process to generate the desired number of lines of the display-corrected image prior to the scan-out deadline;
the scheduler configured to schedule the composition process to start to be executed at the schedule time based on the estimated time before the scan-out deadline.

5. The processor of claim 4, further configured to determine the desired number of lines of the display-corrected image to be generated prior to the scan-out deadline, based on a generation rate of a line of the display-corrected image by the composition process and a scan-out rate of a line of the display-corrected image by the image scan-out operation.

6. The processor of claim 4, further configured to determine the desired number of lines of the display-corrected image to be generated prior to the scan-out deadline, based on the composition process generating a line of the display-corrected image prior to the scan-out deadline of the display-corrected image

7. The processor of claim 3, wherein the scheduler is configured to schedule the composition process at a submission time to start to be executed at the schedule time to start the generation of the desired number of lines of the display-corrected image prior to the scan-out deadline.

8. The processor of claim 7, further configured determine an overhead time between the submission time and the schedule time;
the scheduler further configured to schedule the composition process at the submission time to start to be executed at the schedule time based on the overhead time.

9. The processor of claim 8, further configured to:
determine an estimated time for the composition process to generate the desired number of lines of the display-corrected image prior to the scan-out deadline;
determine the overhead time between the submission time and the schedule time; and
the scheduler configured to schedule the composition process to start to be executed at the schedule time based on the overhead time and the estimated time.

10. The processor of claim 3, wherein the scheduler is configured to statically determine the schedule time based on a deterministic rate of the generation of lines of the display-corrected image by the composition process.

11. The processor of claim 3, wherein the scheduler is configured to dynamically determine the schedule time based on the generation of lines of the display-corrected image by the composition process.

12. The processor of claim 11, wherein the scheduler is configured to dynamically determine the schedule time at run-time of the processor based on a workload of the processor.

13. The processor of claim 3, further configured to:
execute an image rendering process to generate the eyebuffer comprising at least one context layer of an image;
latch the eyebuffer as a latched eyebuffer;
start the execution of the composition process to generate the display-corrected image based on the latched eyebuffer;
determine a preemption time of the image rendering process; and
determine the schedule time to schedule preemption of a current process with the composition process prior to the scan-out deadline, based on the determined preemption time.

14. The processor of claim 13, further configured to determine an estimated time for the composition process to generate the desired number of lines of the display-corrected image prior to the scan-out deadline;
the processor configured to:
determine the schedule time to schedule the preemption of the current process with the composition process prior to the scan-out deadline, based on the determined preemption time and the estimated time.

15. The processor of claim 14, further configured to schedule a new process for the composition process as the current process based on the composition process completing the generation of the remaining number of lines from the display-corrected image after the scan-out deadline.

16. The processor of claim 13 configured to determine the preemption time of the current process as a worst case preemption time of the image rendering process.

17. The processor of claim 1 integrated into an integrated circuit (IC).

18. The processor of claim 1 integrated into a device selected from the group consisting of: a head-mounted device; a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

19. A method of executing a composition process in a processor for generating a display-corrected image to be scanned out to a display device, comprising:
scanning out a display-corrected image starting at a scan-out deadline to a display device;
starting to execute a composition process at a schedule time to generate a desired number of lines of the display-corrected image based on an eyebuffer prior to the scan-out deadline; and
continuing to execute the composition process to generate a remaining number of lines from the display-corrected image after the scan-out deadline and overlapping in time with the scanning out of the display-corrected image after the scan-out deadline.

20. The method of claim 19, further comprising determining the desired number of lines of the display-corrected image to be generated prior to the scan-out deadline, based on a generation rate of a line of the display-corrected image by the composition process and a scan-out rate of a line of the display-corrected image by an image scan-out operation.

21. The method of claim 20, further comprising:
determining an estimated time for the composition process to generate the desired number of lines of the display-corrected image prior to the scan-out deadline;
determining an overhead time between a submission time and the schedule time; and
comprising:
scheduling the composition process to start to be executed at the schedule time based on the overhead time and the estimated time.

22. The method of claim 20, further comprising:
executing an image rendering process to generate the eyebuffer comprising at least one context layer of an image;
latching the eyebuffer as a latched eyebuffer;
executing the composition process to generate the display-corrected image based on the latched eyebuffer;
determining a preemption time of the image rendering process; and
determining the schedule time to schedule preemption of a current process with the composition process prior to the scan-out deadline, based on the determined preemption time.

23. The processor of claim 22, further comprising:
determining an estimated time for the composition process to generate the desired number of lines of the display-corrected image prior to the scan-out deadline; and
comprising:
determining the schedule time to schedule the preemption of the current process with the composition process prior to the scan-out deadline, based on the determined preemption time and the estimated time.

24. A non-transitory computer-readable medium having stored thereon computer executable instructions which, when executed, cause a processor to:
start execution of a composition process at a schedule time to generate a desired number of lines of a display-corrected image based on an eyebuffer prior to a scan-out deadline at which the display-corrected image starts to be scanned out to a display device; and
continue the execution of the composition process to generate a remaining number of lines from the display-corrected image after the scan-out deadline and overlapping in time with the scanning out of the display-corrected image after the scan-out deadline.
